(19) United States
(12) Patent Application Publication
(10) Pub. No.: US 2023/0193633 A1
(43) Pub. Date: Jun. 22, 2023

(54) HEATED WHEELCHAIR RAMP SYSTEM

(71) Applicant: Heated Ramps, LLC, Wyoming, MI (US)

(72) Inventor: Bruce A. Grifhorst, Grand Rapids, MI (US)

(21) Appl. No.: 18/169,968

(22) Filed: Feb. 16, 2023

Related U.S. Application Data
(63) Continuation-in-part of application No. 17/069,786, filed on Oct. 13, 2020, now Pat. No. 11,585,097.
Application No. 17/069,786 is a continuation-in-part of application No. 16/738,700, filed on Jan. 9, 2020, now Pat. No. 10,801,211.
(60) Provisional application No. 62/790,282, filed on Jan. 9, 2019.

(51) Int. Cl. E04F 11/00; H05B 3/56

(52) U.S. Cl. CPC E04F 11/002; H05B 3/56; E04F 11/1808

(57) ABSTRACT

A wheelchair ramp system includes a ramp having a floor having a plurality of layers. At least one guardrail is secured to the side of the ramp for providing a safety barrier to persons using the ramp system. The plurality of layers include a base, a foil isolator; a heating element, a heating element cover and a flooring cover. The ramp system is divided into a plurality of electrical zones such that not all zones are powered at the same time.

### FIELD OF THE INVENTION

The present invention relates generally to wheelchair ramps and more particularly to a wheelchair ramp with heated floor for use in cold climates.

### BACKGROUND

Wheelchair ramps are well known in the art and often are manufactured of tubular steel or aluminum. Tubular steel is often expensive and difficult to manufacture in view of the varying types so structures the ramp is often used. Moreover, an additional problem associated with these ramps occurs in cold climates when snow and ice buildup on the ramp's surfaces. Difficult cold climate conditions can prevent safe ingress and egress from the building. Thus, new ramp solutions are required to overcome these drawbacks.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1A is a cross-sectional view illustrating the components in a heated wheelchair ramp system in accordance with an embodiment of the invention.

FIG. 1B is perspective view illustrating the cable routed in the channel to provide heat to the panel.

FIG. 2 is a side view illustrating the heated wheelchair ramp shown in FIG. 1.

FIG. 3 illustrates a side view of the heated wheelchair ramp system in accordance with an embodiment of the invention.

FIG. 4 a perspective view illustrating the melting of ice on the ramp when heat is applied to the system as described herein.

FIG. 5 is a side view illustrating the joinder of two SIP panels.

FIG. 6A is a perspective view showing the guard rail attached to the ramp system.

FIG. 6B is a side view of the guide rail attached to the ramp system.

FIG. 7 illustrates a side view of the wheelchair ramp system according to an alternative embodiment of the invention.

FIG. 8A, FIG. 8B, FIG. 8C and FIG. 8D illustrate top, side, front and perspective views respectively of an angle bracket used to brace the SIP panel used in the embodiment of FIG. 7.

FIG. 9A is a perspective view showing a headed ramp system in a first alternative embodiment of the invention.

FIG. 9B is a perspective view of a heated ramp system according to a second alternative embodiment of the invention.

FIG. 10 is an exploded view illustrating layers of the ramp system shown in FIG. 9.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a heated wheelchair ramp. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

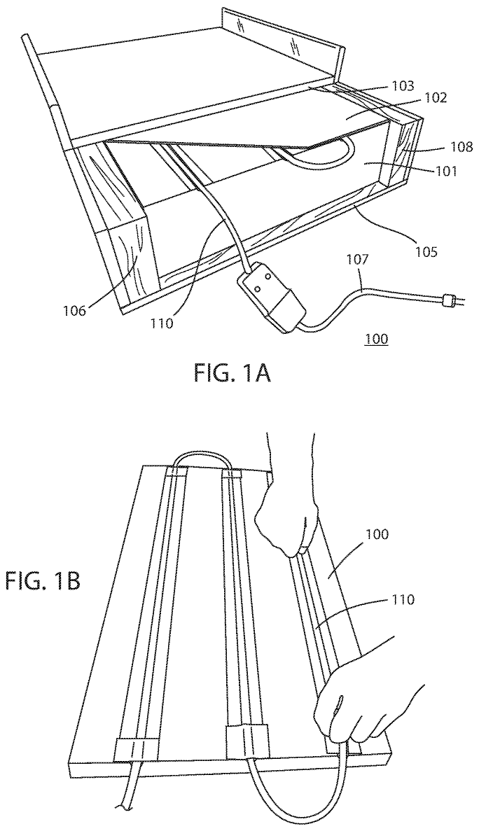

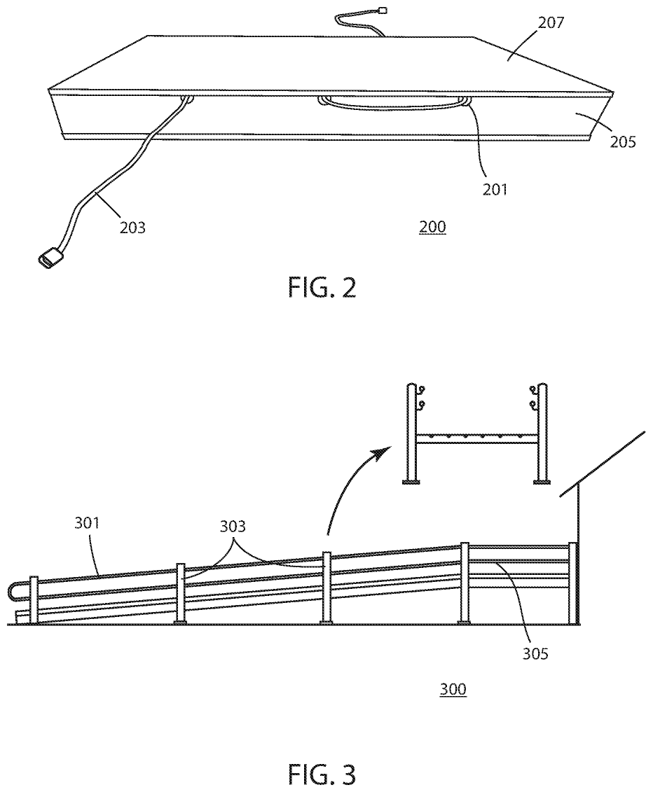

FIG. 1A is a cross-sectional view illustrating the components in a heated wheelchair ramp system in accordance with an embodiment of the invention. FIG. 1B is perspective view illustrating the cable routed in the channel to provide heat to the panel. FIG. 2 is a side view illustrating the heated wheelchair ramp shown in FIG. 1. The wheelchair ramp floor 100 is comprised of a structural insulated panel (SIP). The SIP is a high-performance building system used for both residential and light commercial construction. As seen in FIG. 1A, FIG. 1B and FIG. 2, the SIP consists of an insulating foam core 101 sandwiched between two structural facings 103, 105, side member 106 and side member 108. The side members 106, 108 might be made of 2-inch×4-inch lumber or the like. A top structural facing 103 and bottom structural facing 105 are sheets of material that are typically manufactured of oriented strand board (OSB). Those skilled in the art will recognize that marine plywood, wolmanized plywood, regular, OSB and/or structural panel sheet might also be used as well. As further described herein, a heating cable 110 is configured within the foam core 101 to provide and radiate heat into the foam core 101. A metallic heat conductor, such as aluminum sheet 102 is used under the top structural facing 103 to distribute heat across the top structure facing 103 enabling ice and snow to be easily melted. An AC electrical connector 107 provides power to the heating cable 110 typically rated at at least 3 watts/ft. The heating cable 110 is typically installed in a serpentine shape for providing conductive heat transfer to as much surface area of the structural facing as possible.

As used herein, SIPs are often used for exterior walls, roof panels, and sub-floors and are typically not manufactured as a “stand-alone” product for use outdoors. Those skilled in the art will recognize that moisture, mold, and rot can occur with a SIP if the product does not have a water and/or vapor barrier. Typically, the water barrier used for a SIP might be either siding or roofing. For this reason, SIPs have not been used for a wheelchair ramp application, since any SIP without a barrier cannot withstand the outside elements or having the durability needed the withstand the wear that would be present from a from a motorized wheelchair.

In order to provide a barrier to the elements, the present invention uses a water or vapor coating in the ramp system 100. By way of example and not limitation, a polyaspartic coating may be used on the top structural facing 103 and bottom structural facing 105. An outdoor or exterior coating such as polyaspartic is a protective steel coating, offering corrosion prevention for bridges and other harsh environment applications. Polyaspartic resins offer many benefits over traditional resins such as higher abrasion resistance, chemical resistance, faster installation, and higher overall performance. The 100% solids version has no odor, solvent, or VOCs. As polyaspartic technology has evolved, polyaspartic floor coating systems have been found beneficial as a structural element of the present invention. Thus, although SIPs are not typically used in an outdoor application, the invention transforms a typically interior product to an exterior product though the use of polyaspartic resin.

In order to prevent snow and ice from accumulating on the ramp, the ramp also includes a heating cable configured into the SIPS panel. FIG. 2 shows the SIP 200 with a channel 201 included therein where a heating cable 203 is routed through the channel 201. The heating cable 203 is an electric cable that works to heat a metallic sheet 205 enabling the surface of the top structural facing 207 to remain clear of snow and ice. Those skilled in the art will further recognize, that the channel is cut into the foam of the SIP over the length of the panel just below the top sheet of OSB and metallic sheet 205. Although the heating cable 203 might typically be used for melting snow and ice on roofs, it also works well for a heated wheelchair ramp application. Although a hydronics heating system is typically used for an “in floor applications” that uses heated water in a tube, the channel and heated cable works very well to melt ice and snow. Thus, the construction of the present invention using a SIPs panel permits the use of a heated cable, which is more cost effective than a radiant hydronic system.

FIG. 3 is an illustration of a side view of the heated wheelchair ramp system in accordance with a wheelchair ramp system 300. In still another aspect of the invention, the heated wheelchair ramp can also use an aluminum continuous handrail 301. The use of a handrail is needed in order for the ramp system to be ADA compliant. In one application, the handrail product used might be that made by Digger Specialties Inc. This handrail 301 is multipurpose rail and can be used as either a handrail or guardrail. As seen in FIG. 3, the handrail 301 is attached to 4-inch×4-inch posts 303 every 6-8 feet. The handrail 301 is installed horizontally at the height of approximately 36 inches and a second will be installed at 18″, therefore also making a “guardrail” 305.

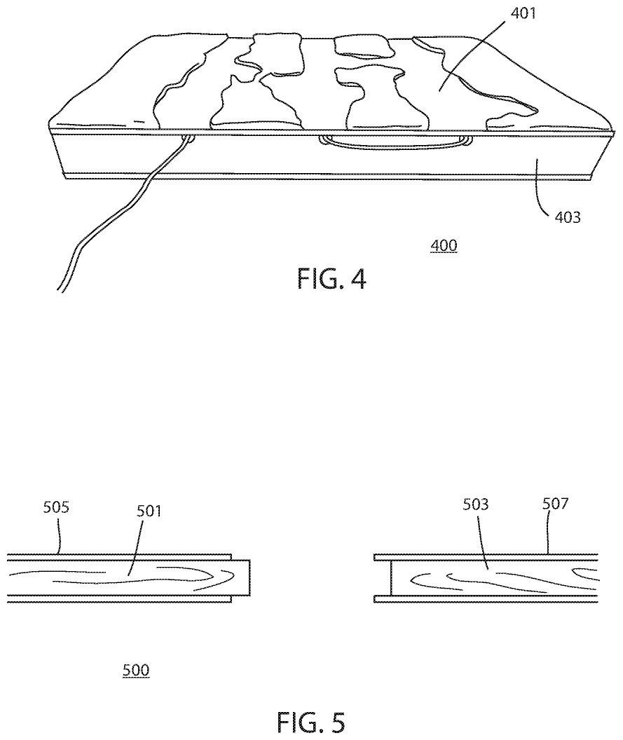

FIG. 4 illustrates the heated wheelchair ramp system 400 as described herein where ice 401 is melting on the ramp 400 when heat is applied to the system. As described herein, the metallic sheet 403 under the top structure facing works to more evenly distribute the heat. Although a wheelchair ramp is described herein, those skilled in the art will recognize that other applications are also possibilities such as pedestrian bridges, boat docks, decks, sidewalks or the like using alternative configurations of SIPs, polyaspartic coating and heating elements are also possible.

FIG. 5 is a side view illustrating joiner inter-locking SIP panels. In this example, a first 2-inch×4-inch member has a protruded end while a second or receiving 2-inch×4-inch member has an intruded end allowing the SIP panel surfaces 505, 507 to be easily join together during construction making a contiguous, uninterrupted surface for walking or rolling a wheel chair or the like. Thus, both the 2×4 inch member and the foam may include a protruded or intruded end to facilitate a seamless type joint.

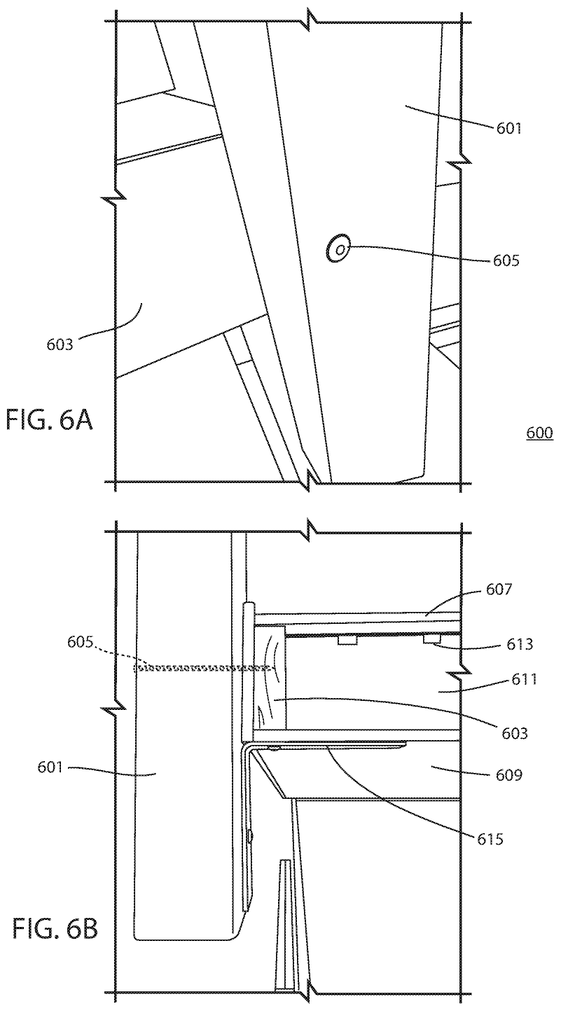

FIG. 6A is a perspective view showing the guard rail attached to the ramp system. FIG. 6B is a side view of the guide rail attached to the ramp system. With regard to both FIG. 6A and FIG. 6B, the guide rail post assembly 600 includes one or more posts 601 that are fastened to a side member 603 of the rail system. As described herein, the side member 603 may be a 2 in ×4 in or the like. The top structural facing 607 and bottom structural facing 609 are shown as the outside surfaces to the foam 611 and metallic sheet 613. Further, the guide rail assembly 600 uses a first fastener 605 such as a screw or the like that is driven orthogonally though the post 601 into the side member 603. A second fastener such as L-bracket 615 works to firmly secure the post 601, side member 603 and bottom structural facing 609 together. This allows the post 601 and guard rail system 600 to be firmly held in a fixed position.

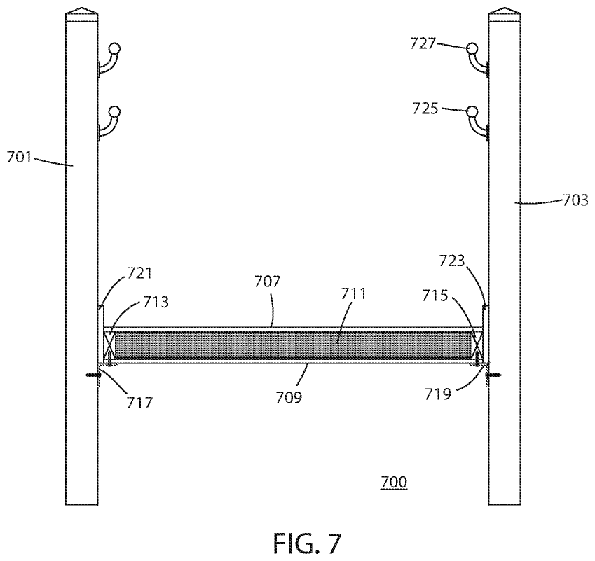

FIG. 7 illustrates a side view of the wheelchair ramp system according to an alternative embodiment of the invention. A wheelchair ramp system 700 includes a first plurality of side rails 701 and a second plurality of side rails 703. The first plurality of side rails 701 and second plurality of side rails 703 can typically be made of 4-inch×4-inch wolmanized pose with a vinyl sleeve.

Spanning between the side rails is at least one SIP panel 705 that is used to form the flooring surface suspending above the ground. As described herein, the SIP panel includes a top substrate 707 and bottom substrate 709 where an EPS foam center core 711 is configured between the top and bottom substrates to provide support yet forming a strong supporting surface. The top substrate 707 and bottom substrate 709 are typically manufacture of wolmanized plywood or fiberglass reinforced panels (FRP) board. A first support 713 and second support 715 may be 2-inch×4-inch boards that wedge the center core 711 laterally between a respective one of the first plurality of side rails 701 and second plurality of side rails 703. Spacers 721, 723 are configured adjacent to the first support 713 and second support 715 respectively to adjust spacing of the SIP panel 705 between a first side rail 701 and second side rail 703. Those skilled in the art will further recognize that the first support 713 and second support 715 may also be manufactured of wolmanized wood or the like for enduring moist weather conditions without wood rot or deterioration. A first plurality of support brackets 717 and second plurality of support brackets 719 work to further support the SIP panel 705 by attaching the underside of each SIP panel 705 to the side of respective support.

Finally, a plurality of rail brackets 725 are used hold a continuous hand rail 727 to the side of the first plurality of side rails 701 and second plurality of side rails 703. Thus, in the wheelchair ramp system as described in FIG. 7, the top and the bottom substrate is an exterior structural panel are typically constructed of materials intended to be used outdoors. In the embodiment, no heating element is used. A structurally insulated panel (SIPS) is used as a support base where a foam core is sandwiched pressed and/or glued between a top and bottom substrate. A rail and post arrangement work to provide support and safety to persons using the ramp system.

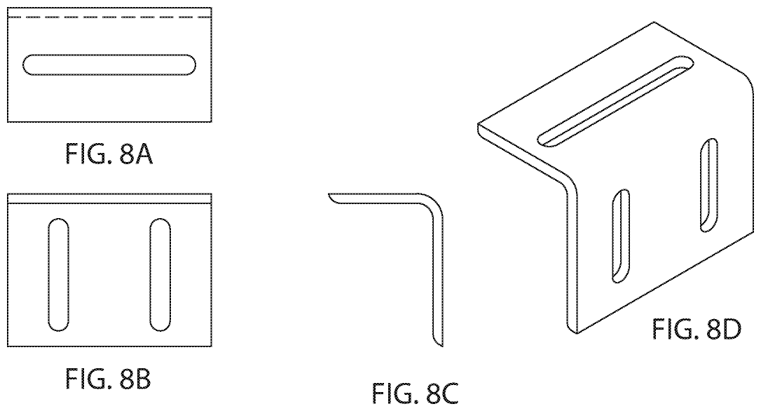

FIG. 8A, FIG. 8B, FIG. 8C and FIG. 8D illustrate top, side, front and perspective views respectively of an support bracket used to brace the SIP panel used in the embodiment of FIG. 7. Each support bracket is manufactured of steel such as angle iron having one or more elongated slots of adjusting its position while attached while under the SIP and to the side of a respective side rail.

Thus, the wheelchair ramp system as described in FIGs FIG. 1 to FIGS. 8A, 8B, 8C and 8D, is unique in its use of SIPS panels for the infrastructure for a wheelchair ramp. The SIPS panels are used with a unique coating, with heated floor and rail. The wheelchair ramp system as described herein, has the ability of being completely free standing, as it has a load capability of approximately 60 pounds per square foot (lbs/sq-ft). Since the SIPS panels are manufactured in 4 ft×24 ft long sections, this enables the ramp construction to span 24 feet without any added support. The present invention can withstand the harshest weather conditions, because of the characteristics of the polyaspartic coating. Moreover, SIPS are used with a railing system, enabling the wheelchair ramp to be custom designed to any application.

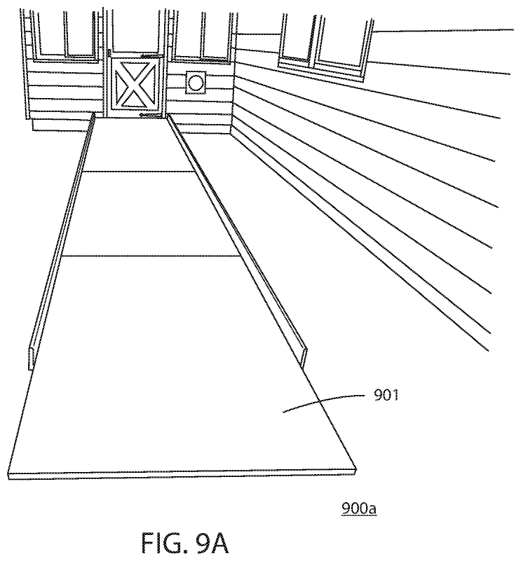

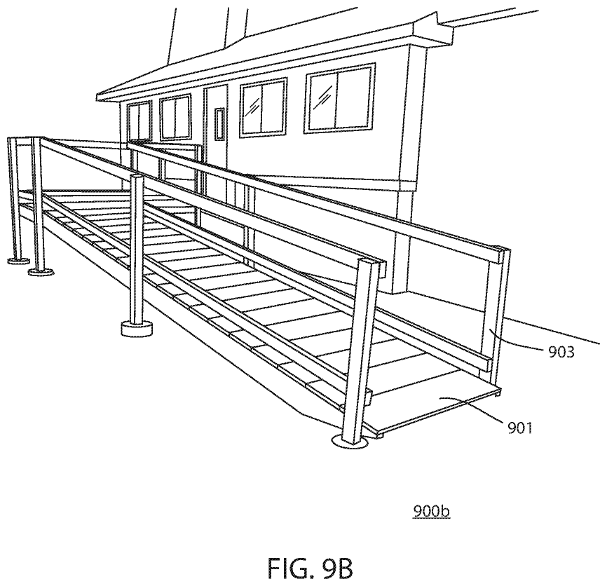

FIG. 9A and FIG. 9B illustrate perspective views of the wheelchair ramp system according various embodiments of the invention. More specifically, FIG. 9A illustrates an embodiment of the wheelchair ramp system 900a that bridges two points in space without the use of a guardrail. In FIG. 9A, this embodiment is shown with a substantially a flat ramp surface while in the second embodiment shown in FIG. 9B, a guard rail 903 is shown. In use, the wheelchair ramp system 900a, 900b is not limited to the “ramp” incline area but instead may include flat areas for turns, landings, and approaches for allowing safe ingress and egress from any building or structure where the ramp system is used.

As will be described herein, the wheelchair ramp system 900a, 900b includes a plurality of mechanically interconnected panels that each use a substantially flat heating element therein. Each of the panels are sized for easy assembly and shipping. Those skilled in the art will further recognize that the invention as set forth herein, can be used directly on top of any supporting surface such as a wood ramp platform and concrete sidewalk supporting surfaces.

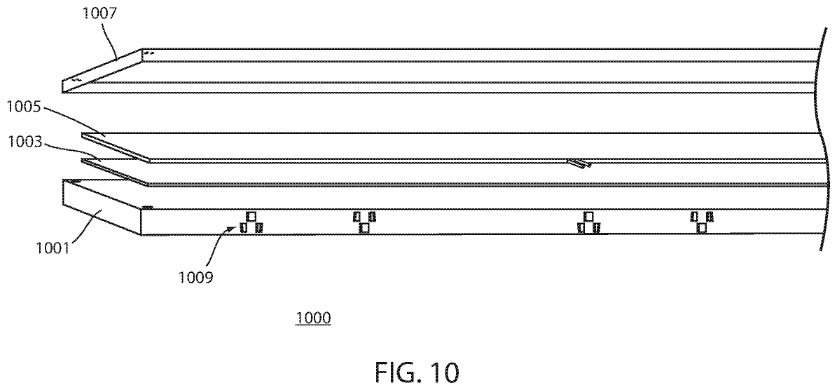

FIG. 10 is an exploded side view illustrating the various layers of the ramp system shown in FIG. 9A and FIG. 9B. The heated wheelchair ramp system 1000 includes a plurality of panels forming a ramp floor with each panel having a base layer 1001. Although the base layer 1001 can be made of wood, the base layer is typically made of dimensional polyvinyl chloride (PVC) lumber allowing it to be waterproof and immune from the environmental elements.

In one embodiment, each panel can include a base layer 1001 manufactured with a void or pocket one side where the various layers of the heated wheelchair ramp system are properly sized to fit with the void of each panel. One or more apertures or holes are formed in the base layer around its perimeter allowing each panel to be screwed down to plywood or other fixed surface. In a second or preferred embodiment, the pocket or void is configured within a flooring cover 1007.

Further, a foil layer 1003 is positioned on top of the base layer 1001 so to prevent heat generated by an electric heating element 1005 to propagate forward and not back into the base layer 1001. The foil layer 1003 is made of a metalized film that acts as a thermal barrier. The metalized film is comprised having a internal layer of high strength woven fabric with a metalized film laminated to its top and bottom. A thin anticorrosive coating is typically added to both exterior metalized film surfaces to maintain surface reflectivity and prevent any loss of aluminum particles preventing corrosion. In use, the foil layer 1003 reflects and/or blocks approximately 95% of the radiant heat from the heating element 1005 and is wrinkle resistant. During assembly, the foil layer 1003 lays flat within the void of the base layer 1001 or top layer 1007 for a clean installation appearance.

The heating element 1005 is configured as a radiating flat matted surface that operates to generate heat using non-embedded electric radiant heating methods typically powered by 125 VAC. The heating element 1005 can be installed either with a direct nail or in a glue down process. Since the heating element 1005 is not embedded within a material, no self-levelling cement is needed. This makes the heating element 1005 easily compatible with the base layer 1001 and foil layer 1003 since it only needs to be configured in a sandwich like configuration.

As noted herein, a heating element cover 1005 covers the heating element preventing damage from persons walking and rolling the wheelchair on the heating element 1005. The flooring cover 1007 is typically a plastic cover which is either solid having no holes, or one having a plurality weeping apertures. The type having a plurality of weeping apertures allows water produced from melting snow and/or ice to pass therethrough while the solid layer the water will flow off the top. As noted above, in the preferred embodiment, the flooring cover 1007 includes the void or pocket one side instead of the base layer 1001. In this embodiment, the pocket is configured under the flooring cover 1007, and the cover is sized to fit over and around the base layer 1001 so it can be attached thereto.

Finally, one or more triangular shaped clips 1009 are configured on the base layer 1001 allowing each panel to snap together. Thus, the various panels can be physically interconnected to any needed ramp length. The AC electrical connection connects separately to each heating element 1005 allowing it to be powered to produce heat to melt snow and ice. To deliver maximum power for melting snow or ice, a control system may be utilized to cycle power to different zones of the ramp. The power available from a conventional residential electrical circuit is 15 A at 120 VAC=1,800 Watts with a safety margin not to exceed 1,500 Watts. This typically is not enough power to melt snow or ice over a surface area of 4′×40′ (160 square feet). The watt density, in such a scenario, would be less than 9.5 W/ft². Thus, the power supplied the ramp can be managed by splitting the ramp area into five electrical zones. Since all zones are not powered at the same time. For example, with a 32 ft² ramp, electrical watt density will be increased five times with a 20% positive duty cycle.

Thus, embodiments of the present invention are directed to a wheelchair ramp system that includes a plurality of panels each having a foil isolator layer, at least one heating element and at least one heating element cover each sized to fit within a void of a base layer. At least one guardrail is secured to the side of the base layer for providing a safety barrier to persons using the ramp system. Each panel is serially interconnected using clips on the side of the base for providing continuously heated surface for melting snow and ice.

In the foregoing specification, specific embodiments of the present invention have been described. However, one of ordinary skill in the art appreciates that various modifications and changes can be made without departing from the scope of the present invention as set forth in the claims below.

Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A wheelchair ramp system comprising:
a ramp having a floor having a plurality of layers;
at least one guardrail secured to the side of the ramp for providing a safety barrier to persons using the ramp system; and
wherein the plurality of layers include a base, a foil isolator; a heating element and a flooring cover.

2. A wheelchair ramp system as in claim 1, wherein the flooring cover includes a hollow void therein for holding the base, foil isolator and heating element.

3. A wheelchair ramp system as in claim 1, wherein the foil isolator is metallic and works to prevent heat from the heating element escaping into the base.

4. A wheelchair ramp system as in claim 1, wherein the base layer includes manufactured from polyvinyl chloride (PVC).

5. A wheelchair ramp system as in claim 1, wherein the ramp system is divided t into a plurality of electrical zones such that not all zones are powered at the same time.

6. A wheelchair ramp system in claim 1, wherein the floor includes a substantially flat area for allowing turns, landings, and approaches to the ramp system.

7. A wheelchair ramp system comprising:
a ramp surface forming a floor and constructed from a plurality of sandwiched elements;
a flooring cover having a hollow void; and
wherein the plurality of sandwiched elements includes a base, a foil isolator and at least one heating element that are sized to fit within the hollow void.

8. A wheelchair ramp system as in claim 7, further comprising:
at least one guardrail configured at the side of the ramp for providing a safety barrier to persons using the ramp system.

9. A wheelchair ramp system as in claim 7, wherein the base is made of a polyvinyl chloride (PVC).

10. A wheelchair ramp system as in claim 7, wherein the at least one heating element is electrically connected to 125 VAC.

11. A wheelchair ramp system as in claim 7, wherein the ramp system is divided into a plurality of electrical zones such that not all zones are powered at the same time.

12. A wheelchair ramp system in claim 7, wherein the floor includes a substantially flat area for allowing turns, landings, and approaches to the ramp system.

13. A wheelchair ramp system as in claim 6, wherein the flooring cover is a solid surface preventing melted water from passing therethrough.

14. A wheelchair ramp system comprising:
a plurality of panels each having a base, a foil isolator layer, at least one heating element and at least one flooring cover such that the base, foil isolator layer and heating element each are sized to fit within a void of the flooring cover;
at least one guardrail secured to the side of the base layer for providing a safety barrier to persons using the ramp system; and
wherein each panel is serially interconnected using clips on the side of the base for providing continuously heated surface for melting snow and ice.

15. A wheelchair ramp system in claim 14, wherein the floor includes a substantially flat area for allowing turns, landings, and approaches to the ramp system.

16. A wheelchair ramp system as in claim 14, wherein foil isolator layer prevents heat from propagating into the base layer.

17. A wheelchair ramp system as in claim 14, wherein the at least one heating element is configured as flat matt like shape.

18. A wheelchair ramp system as in claim 14, wherein the ramp system is divided into a plurality of electrical zones such that not all zones are powered at the same time.
